(19) United States
(12) Patent Application Publication
(10) Pub. No.: US 2026/0281255 A1
(43) Pub. Date: Sep. 17, 2026

(54) DETECTION SYSTEM, DETECTION METHOD, AND IMAGE FORMING APPARATUS

(71) Applicant: Taiga INOUE, Tokyo (JP)

(72) Inventor: Taiga INOUE, Tokyo (JP)

(73) Assignee: Ricoh Company, Ltd., Tokyo (JP)

(21) Appl. No.: 19/566,547

(22) Filed: Mar. 13, 2026

(30) Foreign Application Priority Data
Mar. 17, 2025 (JP) 2025-042767
Jan. 30, 2026 (JP) 2026-014561

(51) Int. Cl. H04N 1/00; B08B 1/30; G03G 15/00; G03G 15/22

(52) U.S. Cl. CPC H04N 1/00037; B08B 1/30; G03G 15/228; G03G 15/5016; G03G 15/55; H04N 1/00013; H04N 1/00074; H04N 1/00082

(57) ABSTRACT

A detection system includes an image reader, circuitry, a display, and a cleaner. The image reader has a reading face to read, in a scanning direction, an image on a sheet fed on the reading face. The circuitry is to detect a foreign matter adhered to the reading face, and calculate a distance, in the scanning direction, between an adhesion point where the foreign matter is adhered to the reading face and a reference point on the reading face. The display displays the distance calculated. The cleaner has a scale in the scanning direction. The scale corresponds to the distance displayed on the display, and is movable in the scanning direction to remove the foreign matter adhered to the reading face.

### CROSS-REFERENCE TO RELATED APPLICATIONS

This patent application is based on and claims priority pursuant to 35 U.S.C. § 119(a) to Japanese Patent Application Nos. 2025-042767, filed on Mar. 17, 2025, and 2026-014561, filed on Jan. 30, 2026, in the Japan Patent Office, the entire disclosure of each of which is hereby incorporated by reference herein.

### BACKGROUND

### Technical Field

Embodiments of the present disclosure relate to a detection system, a detection method, and an image forming apparatus incorporating the detection system.

### Related Art

Image forming apparatuses in the art provide the technique of identifying the position of adhesion of dust. In such a technique, a report on which the main scanning position of adhesion of dust is printed and a positioning mark corresponding to the position printed on the report are provided on an image reader. By so doing, a user can easily recognize the position to be cleaned.

Further, other image forming apparatuses in the art include a configuration that detects a dust adhesion point of the image reader, calculates the distance from a reference point to a cleaning target portion based on the detection data, and output a notification to a user of the calculated distance, in order to prevent a wasteful cleaning operation from being performed as much as possible by performing a cleaning operation on the image reader only when necessary.

However, in the above-described technique of identifying the position of adhesion of dust, the positioning mark provided to the image reader is to be visually checked and the cleaning target portion is to be identified. For this reason, in a case where the image reader is installed facing downward, the user needs to take time and effort to check the positioning mark by looking into the image reader from below. Further, when multiple image readers are provided, a positioning mark needs to be given to each image reader.

### SUMMARY

Embodiments of the present disclosure described herein provide a novel detection system including an image reader, circuitry, a display, and a cleaner. The image reader has a reading face to read, in a scanning direction, an image on a sheet fed on the reading face. The circuitry is to detect a foreign matter adhered to the reading face, and calculate a distance, in the scanning direction, between an adhesion point where the foreign matter is adhered to the reading face and a reference point on the reading face. The display displays the distance calculated. The cleaner has a scale in the scanning direction. The scale corresponds to the distance displayed on the display, and is movable in the scanning direction to remove the foreign matter adhered to the reading face.

Further, embodiments of the present disclosure described herein provide an image forming system including the above-described detection system.

Further, embodiments of the present disclosure described herein provide a detection method that is executed in a detection system and that includes detecting a foreign matter adhered to a reading face of an image reader, calculating a distance, in a scanning direction, between an adhesion point where the foreign matter is adhered to the reading face and a reference point on the reading face of the image reader, displaying the distance calculated, and removing the foreign matter adhered to the reading face of the image reader by a cleaner having a scale in the scanning direction, the scale corresponding to the distance displayed on the display.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1-1 is a diagram illustrating a system configuration of an image forming apparatus according to a first embodiment of the present disclosure;

FIG. 1-2 is a diagram illustrating a hardware configuration of a printer according to a first embodiment of the present disclosure;

FIG. 1-3 is a block diagram of a functional block of a printer according to a first embodiment of the present disclosure;

FIG. 1-4 is a diagram illustrating a hardware configuration of a detection system according to a first embodiment of the present disclosure;

FIG. 1-5 is a diagram illustrating a configuration of a detection system according to a first embodiment of the present disclosure;

FIG. 2 is a diagram illustrating a configuration of a cleaning member included in a detection system according to a first embodiment of the present disclosure;

FIG. 3 is a diagram illustrating an example of an inspection target image in a case where a dust adheres to a reading face when the image reader of the detection system according to the first embodiment performs reading without feeding a sheet;

FIG. 4 is a diagram illustrating an example of a method of performing a cleaning of a reading face in a detection system according to a first embodiment of the present disclosure;

FIG. 5 is a flowchart of a cleaning operation on a reading face in a detection system according to a first embodiment of the present disclosure;

FIGS. 6A and 6B are diagrams illustrating an example of an image reader with a guide in a detection system according to a first embodiment of the present disclosure;

FIG. 7-1 is a diagram illustrating an example of a functional configuration of a detection system according to a second embodiment of the present disclosure;

FIG. 7-2 is a diagram illustrating an example of an automatic cleaning on a reading face in a detection system according to a second embodiment of the present disclosure; and

FIG. 8 is a flowchart of an example of a cleaning operation on a reading face in a detection system according to a second embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

A detailed description is given below of a detection system, a detection method, and an image forming apparatus, with reference to the drawings.

### First Embodiment

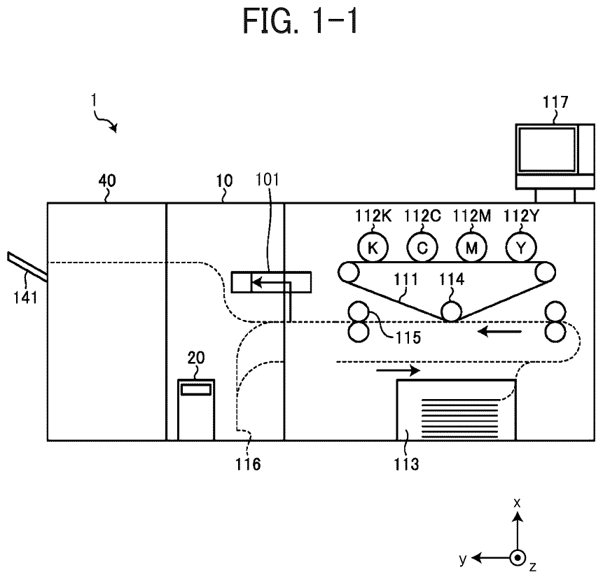

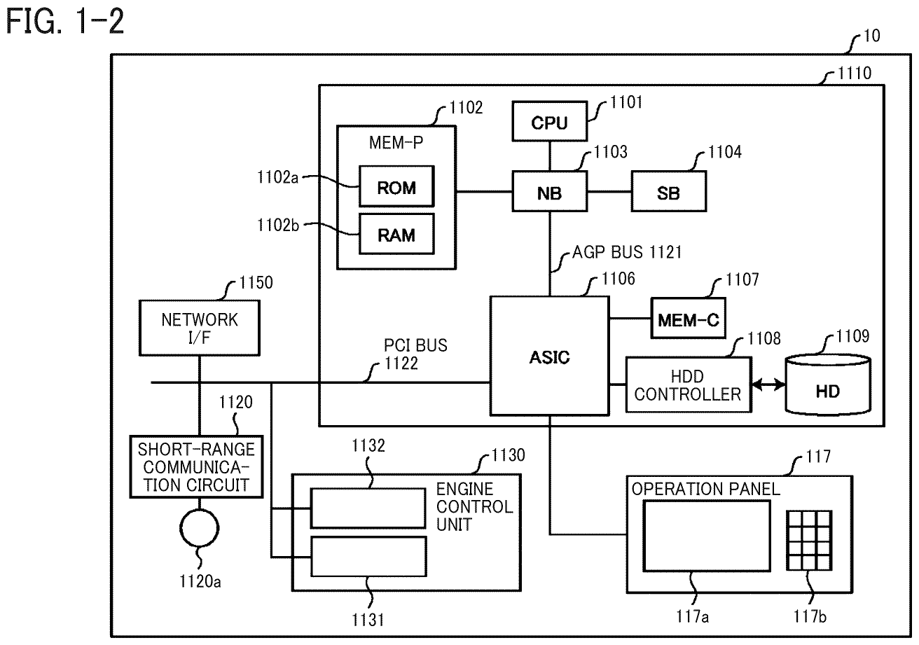

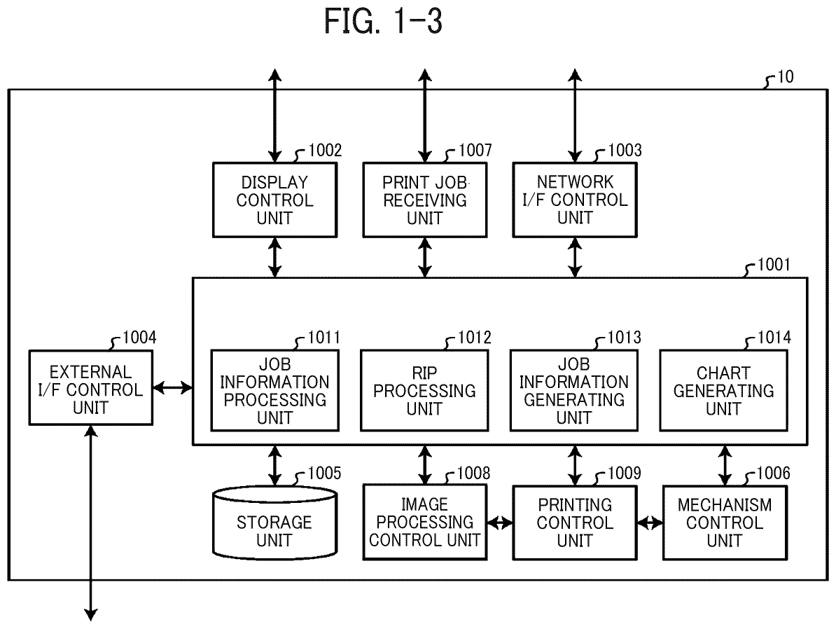

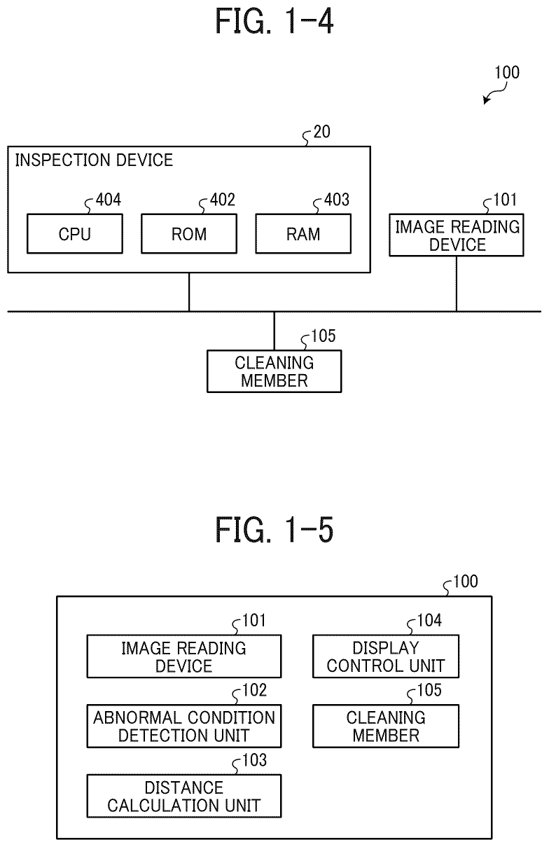

FIG. 1-1 is a diagram illustrating an example of a system configuration of an image forming apparatus according to a first embodiment of the present disclosure.

In FIG. 1-1, an “x direction” represents a vertical direction of the image forming apparatus 1, a “y direction” represents a direction in which a recording medium such as a sheet is conveyed (sub-scanning direction), and a “z direction” represents a front-rear direction of an operation panel 117 (main scanning direction in which an image reading device 101 performs scanning).

An image forming apparatus 1 includes a printer 10, an inspection device 20, and a stacker 40.

The printer 10, the inspection device 20, and the stacker 40 of the image forming apparatus 1 are communicatively coupled to each other via a communication line or a communication network.

The printer 10 receives print job data including a user image from an external device such as a digital front end (DFE) 30. Then, the printer 10 executes printing in response to receipt of an execution instruction based on the received print job data or a user operation on the operation panel 117 of the printer 10. The print job data includes data including job information indicating attributes of the job such as the number of copies to be printed, the number of pages to be printed, the printing mode between a duplex printing mode and a single-sided printing mode, and the sheet type, and image data.

The printer 10 includes photoconductor drums 112Y, 112M, 112C, and 112K disposed along a conveyance belt 111. The photoconductor drums 112Y, 112M, 112C, and 112K form yellow (Y), magenta (M), cyan (C), and black (K) toner images, respectively. The conveyance belt 111 is an endless moving unit of an endless loop.

Specifically, the printer 10 includes the photoconductor drums 112Y, 112M, 112C, and 112K disposed in this order from upstream of the conveyance direction of the conveyance belt 111. The conveyance belt 111 is an intermediate transfer belt on which an intermediate transfer image to be transferred onto a sheet fed from a sheet tray 113 along the conveyance belt 111 is formed. The sheet is an example of a medium on which a color image is formed.

The printer 10 transfers respective images of black (K), cyan (C), magenta (M), and yellow (Y), which are developed with toner on respective surfaces of the photoconductor drums 112Y, 112M, 112C, and 112K for the four colors, onto the conveyance belt 111 in a superimposing manner to form a full color image. These colors are examples of a first color and a second color, and the toner images of these colors are examples of multiple images that are superimposed on a medium to form a color image.

The printer 10 transfers the full color image formed on the conveyance belt 111 onto the sheet that has been conveyed by a transfer roller 114 along a sheet conveyance path, at a position at which the full color image comes closest to the sheet conveyance path indicated with broken lines in FIG. 1-1. Accordingly, the full color image is formed on the sheet.

The printer 10 further conveys the sheet having the image on the surface, so that the image is fixed to the sheet by a fixing roller pair 115. Then, the sheet is conveyed to an image reading device 101 as an image reader disposed downstream from the fixing roller pair 115 in a conveyance direction of the sheet. The image reading device 101 as an image reader has a reading face, and reads the sheet conveyed through the fixing roller pair 115 via the reading face, generates read image data, and is input to an inspection device 20. The read image is, for example, in the red, green, and blue (RGB) format with 8-bit colors and 200 dpi resolution. The image reading device 101 may read the full color image after the full color image is fixed to the sheet by the fixing roller pair 115. Alternatively, the image reading device 101 may read the full color image before the sheet enters the fixing roller pair 115 after the full color image is transferred by the transfer roller 114.

In the case of single-side printing, the printer 10 directly ejects the sheet read by the image reading device 101 to the stacker 40. In the case of duplex printing, the printer 10 reverses the sheet read by the image reading device 101, in a sheet reverse path 116, and then conveys the sheet to a transfer position of the transfer roller 114 again.

Subsequently, the printer 10 transfers and fixes the toner image to the opposite side of the sheet printed on one side. Then, the image reading device 101 reads the printed surface. Subsequently, the printer 10 ejects the duplex printed sheet to the stacker 40.

The stacker 40 stacks and stores sheets ejected from the printer 10 on a sheet ejection tray 141.

The inspection device 20 inspects the read image read by the image reading device 101 by a method described below, and detects a positional deviation (positional deviation information) occurring at the time of printing. The operation panel 117 acquires information indicating an inspection result from the inspection device 20 and displays the information.

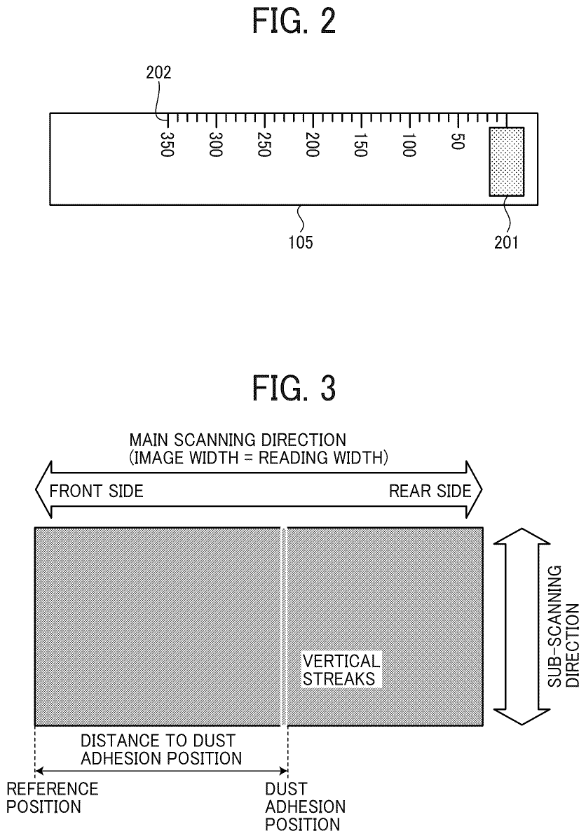

Referring to FIG. 1-2, a description is given of an example of the hardware configuration of the printer 10 according to the present embodiment.

FIG. 1-2 is a diagram illustrating the hardware configuration of the printer according to a first embodiment of the present disclosure.

The hardware configuration of the printer 10 illustrated in FIG. 1-2 is an example of the hardware configuration of the printer 10 of the image forming apparatus 1 that includes a detection system 100.

The printer 10 includes a controller 1110, a short-range communication circuit 1120, an engine control unit 1130, the operation panel 117, and a network interface (I/F) 1150.

The controller 1110 includes a central processing unit (CPU) 1101 that is a main part of a computer, a system memory (MEM-P) 1102, a north bridge (NB) 1103, a south bridge (SB) 1104, an application specific integrated circuit (ASIC) 1106, a local memory (MEM-C) 1107 that is a memory device, a hard disk drive (HDD) controller 1108, and a hard disk (HD) 1109 that is a memory device. A solid state drive (SSD) may be used as the storage device.

The NB 1103 and the ASIC 1106 are connected with an accelerated graphics port (AGP) bus 1121.

The CPU 1101 is a control device that performs overall control of the image forming apparatus 1 including the printer 10. The NB 1103 is a bridge to connect the CPU 1101, the MEM-P 1102, the SB 1104, and the AGP bus 1121. The NB 1103 includes a memory controller that controls reading from and writing to the MEM-P 1102, a peripheral component interconnect (PCI) master, and an AGP target.

The MEM-P 1102 includes a read only memory (ROM) 1102a and a random access memory (RAM) 1102b. The ROM 1102a is a memory to store programs and data for implementing various functions of the controller 1110. The RAM 1102b is a memory to deploy programs or data or to render print data for memory printing. The program stored in the RAM 1102b may be provided as a file in an installable format or an executable format that the program is recorded in a computer-readable storage medium such as a compact disc-read-only memory (CD-ROM), a compact disc-recordable (CD-R), or a digital versatile disc (DVD).

The SB 1104 is a bridge to connect the NB 1103 to PCI devices and peripheral devices. The ASIC 1106 is an integrated circuit (IC) for image processing having a hardware element for image processing and has a role of a bridge that connects the AGP bus 1121, a PCI bus 1122, the HDD controller 1108, and the MEM-C 1107 to each other.

The ASIC 1106 includes a PCI target, an AGP master, an arbiter (ARB) serving as a core of the ASIC 1106, a memory controller that controls the MEM-C 1107, a plurality of direct memory access controllers (DMAC) that rotates image data by hardware logic, and a PCI unit that transfers data between a scanner processing unit 1131 and a printer processing unit 1132 via the PCI bus 1122. A connection to the ASIC 1106 may be established through a universal serial bus (USB) interface or an Institute of Electrical and Electronics Engineers 1394 (IEEE 1394) interface.

The MEM-C 1107 is a local memory used as a copy image buffer and a code buffer. The HD 1109 is a memory device that stores image data, font data used in printing, and forms. The HD 1109 controls the reading or writing of data from or to the HD 1109 under the control of the CPU 1101.

The AGP bus 1121 is a bus interface for a graphics accelerator card that has been proposed to speed up graphics processing. The AGP bus 1121 is a bus that allows direct access to the MEM-P 1102 at high throughput to speed up the graphics accelerator card.

The short-range communication circuit 1120 includes a short-range communication antenna 1120a. The short-range communication circuit 1120 is a communication circuit that communicates in compliance with the near field radio communication (NFC) or the Bluetooth®.

The engine control unit 1130 includes the scanner processing unit 1131 and the printer processing unit 1132. The operation panel 117 includes a panel display 117a and operation keys 117b. The panel display 117a is, e.g., a touch screen that displays current settings or a selection screen that receives a user input. The operation keys 117b include, e.g., a numeric keypad and a start key. The numeric keypad receives setting values of image forming parameters such as an image density parameter. The start key receives an instruction to start copying. The panel display 117a is an example of a display. The panel display 117a receives a touch input from the user. The user can perform operations such as inputting numerical values to an input box displayed on the screen, selecting a pull-down menu, and turning on and off a check box, using, for example, a finger or a pen. The operation keys 117b may include an input device such as a trackball or a touch pad in addition to the numeric keypad.

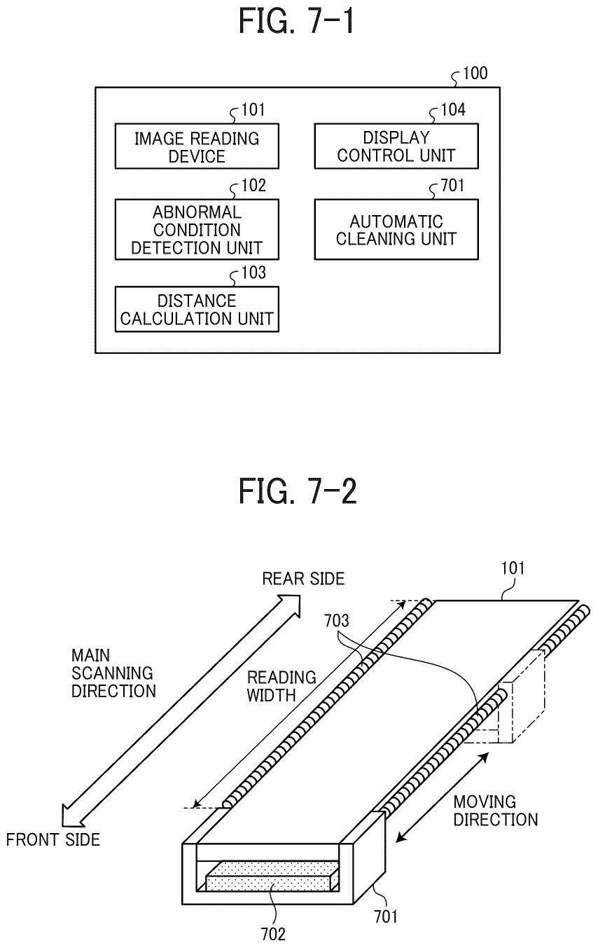

The controller 1110 may control the entire operation of the image forming apparatus 1 including the printer 10. For example, the controller 1110 controls, for example, drawing, communication, input from the operation panel 117, reading of a print result by the image reading device 101, and inspection of read data by the inspection device 20. The controller 1110 controls a detection system 100 (see FIG. 1-4) described below. Specifically, the controller 1110 controls the image reading device 101, the abnormal condition detection unit 102 (see FIG. 1-4), the distance calculation unit 103 (see FIG. 1-4), and the display control unit 104 (see FIG. 1-4). The controller 1110 may control an automatic cleaning unit 701 (see FIG. 7). The scanner processing unit 1131 reads an image formed on a conveyance medium such as a sheet and generates image data. The printer processing unit 1132 includes a transfer device to transfer the image using a color material such as a toner image onto the conveyance medium such as the sheet, a fixing device to fix the image, and a heating device or a drying device, and performs image formation on the sheet. Further, the scanner processing unit 1131 or the printer processing unit 1132 executes image processing such as error diffusion and gamma conversion.

The sheet is an example of the conveyance medium. The conveyance medium may be any medium other than paper, such as a film sheet or a plastic sheet, as long as the conveyance medium is stacked in a sheet tray provided for the printer 10, to be conveyed and output according to an output instruction of a sheet.

The network I/F 1150 is an interface that performs communication of data through the communication network. The short-range communication circuit 1120 and the network I/F 1150 are electrically connected to the ASIC 1106 via the PCI bus 1122.

FIG. 1-2 illustrates the example of the printer 10 having an electrophotographic image forming mechanism.

In some examples, the printer 10 may include another image forming mechanism such as an inkjet image forming mechanism.

A description is given below of an example of the functional configuration of the printer according to the present embodiment with reference to FIG. 1-3.

FIG. 1-3 is a block diagram of the functional block of the printer according to the first embodiment of the present disclosure.

The printer 10 includes a system controller 1001, a display control unit 1002, a network I/F control unit 1003, an external I/F control unit 1004, a storage unit 1005, a mechanism control unit 1006, a print job receiving unit 1007, an image processing control unit 1008, and a printing control unit 1009. Each of these units of the printer 10 is achieved by the CPU 1101 or the ASIC 1106 of the printer 10 executing a process defined in programs stored in the MEM-P 1102 or the MEM-C 1107.

The system controller 1001 controls the overall operation of the printer 10. The system controller 1001 includes a job information processing unit 1011, a raster image processor (RIP) processing unit 1012, a job information generation unit 1013, and a chart generation unit 1014.

The job information processing unit 1011 processes job information included in the print job data transmitted from the DFE. The RIP processing unit 1012 processes the rasterized image data included in the print job data transmitted from the DFE. The rasterized image is, for example, in the CMYK format (format in a subtractive color mode including cyan, magenta, yellow, and black) with 8-bit colors and 600 dpi resolution, and an example of print data (image formation data).

The job information generation unit 1013 generates job information to insert a sheet in response to receipt of information instructing the insertion of the sheet for inspection from the inspection device 20.

The chart generation unit 1014 generates print data in which an inspection chart described below is arranged. The chart generation unit 1014 is an example of an image arrangement unit, and the print data in which the inspection chart is arranged is an example of image formation data.

The display control unit 1002 controls to display various types of information including job information on the operation panel 117. The network I/F control unit 1003 controls the network I/F 1150 and controls connection with the communication network. When another device is connected to the printer 10, the external I/F control unit 1004 controls connection with the connected device. The storage unit 1005 stores various types of information including job information.

The mechanism control unit 1006 controls operations of mechanisms included in the printer 10, such as operations of a mechanism that performs sheet conveyance and operations of a mechanism that performs a transfer process in the printer 10 including the printer processing unit 1132. The print job receiving unit 1007 receives the print job data from the DFE. The image processing control unit 1008 processes a printed image transferred by the mechanism control unit 1006. The printing control unit 1009 controls the image formation on the conveyance medium. The mechanism control unit 1006, the image processing control unit 1008, and the printing control unit 1009 cooperate with each other to function as an image forming unit that forms an image on the conveyance medium.

Referring to FIG. 1-4, a description is given of an example of the hardware configuration of the detection system 100 according to the present embodiment.

FIG. 1-4 is a diagram illustrating the hardware configuration of the detection system according to the first embodiment of the present disclosure.

As illustrated in FIG. 1-4, the detection system 100 according to the present embodiment includes, for example, an inspection device 20 (e.g., a CPU 404, a ROM 402, and a RAM 403), the image reading device 101, and the cleaning member 105. The inspection device 20 includes, for example, the CPU 404 that controls the inspection device 20, the ROM 402 that stores various programs and various types of data, and the RAM 403 that functions as a work area when the CPU 404 executes various programs.

Referring to FIG. 1-5, a description is given of an example of the functional configuration of the detection system 100 according to the present embodiment.

FIG. 1-5 is a diagram illustrating a configuration of the detection system according to the first embodiment of the present disclosure.

In the present embodiment, the detection system 100 includes the image reading device 101, the abnormal condition detection unit 102, the distance calculation unit 103, the display control unit 104, and the cleaning member 105. In the present embodiment, each of the abnormal condition detection unit 102, the distance calculation unit 103, and the display control unit 104 is achieved by the CPU 404 executing various programs stored in the ROM 402 with the RAM 403 as a work area to implement various functions described below.

The image reading device 101 reads an image and transmits the reading result (inspection target image) to the abnormal condition detection unit 102, the distance calculation unit 103, and the display control unit 104. In the present embodiment, the image reading device 101 generates an inspection target image as a reading result as a result of a read image obtained without feeding a sheet. In the present embodiment, the image reading device 101 may include a guide to fix the cleaning member 105 parallel to the reading face of the image reading device 101. Due to such configurations as described above, the cleaning member 105 can be brought into contact with the dust adhesion point at a correct angle, and the dust can be removed more reliably.

The abnormal condition detection unit 102 analyzes the inspection target image, and detects the position of adhesion of a foreign object such as dust on the reading face of the image reading device 101 (referred to as a “dust adhesion point” below). (no translation) In other words, the abnormal condition detection unit 102 detects that dust is attached to the reading face of the image reading device 101.

The distance calculation unit 103 calculates a distance between the adhesion point of the dust (dust adhesion point) detected by the abnormal condition detection unit 102 and a reference point of the image reading device 101 (for example, an end portion of the reading face) as a reference in a first direction of the reading face of the image reading device 101 (for example, the main scanning direction in which the image reading device 101 performs scanning). In the present embodiment, the distance calculation unit 103 calculates the distance from the reference point to the dust adhesion point using the inspection target image.

The display control unit 104 displays the inspection target image and the calculation result by the distance calculation unit 103, on the display such as the panel display 117a. By so doing, the image reading device 101 can detect the adhered dust without feeding the sheet, and the waste sheet can be reduced. The display control unit 104 displays at least a distance calculated by the distance calculation unit 103. In the present embodiment, the display control unit 104 may display the cleaning procedure by causing the cleaning member 105 to contact the guide of the image reading device 101. By so doing, even a user who does not know the cleaning procedure to perform cleaning the reading face of the image reading device 101.

The cleaning member 105 is a cleaning member that is movably disposed in the main scanning direction to remove a foreign matter or dust adhered on the reading face of the image reading device 101. The cleaning member 105 has a scale that is provided along the main scanning direction and corresponds to the distance displayed on the panel display 117a by the display control unit 104. Due to such configurations as described above, since the cleaning member 105 used when cleaning the reading face is provided with the scale to measure the position from the reference point to the cleaning target portion, the cleaning member 105 can be placed at the target position by simply looking a scale of the cleaning member without looking into the image reading device 101 from below and easily perform a cleaning. In other words, the time and effort to look into the image reading device 101 to confirm the dust adhesion point can be reduced.

Further, the cleaning member 105 may include an automatic cleaning member to perform automatic cleaning on the reading face of the image reading device 101 based on the calculation result of the distance by the distance calculation unit 103. By so doing, the time and effort for the user to perform the cleaning operation can be reduced. When it is detected that the detection system has transitioned to a downtime, the automatic cleaning member may perform the automatic cleaning on the reading face of the image reading device 101. For example, when printing is continuously performed for a long time, an operation of temporarily stopping the printing and adjusting the fixing temperature may be performed. This may take several minutes. This operation is referred to as a downtime or a downtime operation. According to such a configuration, the automatic cleaning is also performed behind the downtime, and the time for performing the automatic cleaning can be hidden.

A description is given below of an example of the flow of the configuration of the cleaning member 105 included in the detection system 100 according to the present embodiment with reference to FIG. 2.

FIG. 2 is a diagram illustrating the configuration of the cleaning member included in the detection system according to the first embodiment of the present disclosure.

The cleaning member 105 according to the present embodiment includes a sponge 201 and a scale 202. The sponge 201 is a sponge attached to the end of the cleaning member 105 to remove dust adhered to the reading face of the image reading device 101. The scale 202 is a scale corresponding to the distance calculated by the distance calculation unit 103.

A description is given below of an example of an inspection target image in a case where a dust adheres to the reading face of the image reading device 101 of the detection system 100 when the image reading device 101 performed reading without feeding a sheet, with reference to FIG. 3.

FIG. 3 is a diagram illustrating an example of an inspection target image in a case where a dust adheres to the reading face when the image reading device of the detection system according to the first embodiment performs reading without feeding a sheet.

The lateral direction of the inspection target image corresponds to the main scanning direction, and the image width corresponds to the reading width. It can be confirmed at which position in the main scanning direction the reading streak occurs. The left end of the inspection target image corresponds to the reference point, and the distance calculation unit 103 can calculate the distance from the reference point to the dust adhesion point based on the inspection target image.

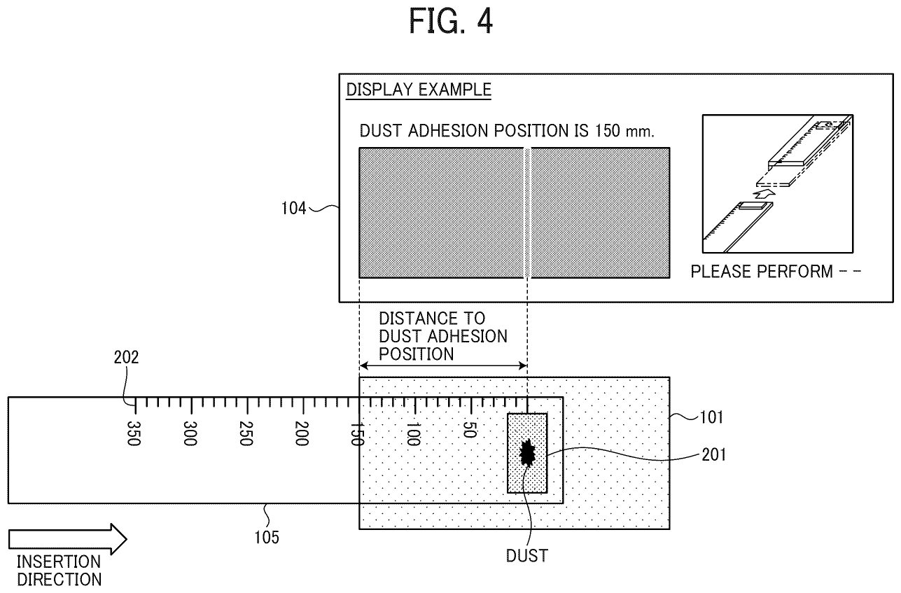

A description is given below of an example of a cleaning method of the reading face in the detection system 100 according to the present embodiment with reference to FIG. 4.

FIG. 4 is a diagram illustrating an example of a method of performing the cleaning of the reading face in the detection system according to the first embodiment of the present disclosure.

The display control unit 104 displays the distance calculated by the distance calculation unit 103 from the reference point to the dust adhesion point, on the panel display 117a. By comparing the numerical value displayed on the panel display 117a with the numerical value of the scale 202 on the cleaning member 105, the user can grasp to which position the cleaning member 105 is to be inserted. For this reason, the user can easily remove the dust without looking into the reading face of the image reading device 101. Further, an image or a movie indicating the procedure for each step may be displayed on the panel display 117a by the display control unit 104 so that even a user who does not know the cleaning procedure can perform the cleansing.

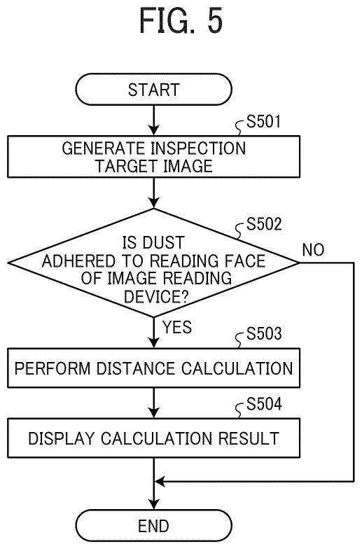

A description is given below of an example of the flow of a cleaning operation on the reading face in the detection system 100 according to the present embodiment with reference to FIG. 5.

FIG. 5 is a flowchart of an example of the cleaning operation on the reading face in the detection system according to the first embodiment of the present disclosure.

Firstly, the image reading device 101 generates an inspection target image without feeding a sheet (step S501), and sends the inspection target image to the abnormal condition detection unit 102, the distance calculation unit 103, and the display control unit 104.

Subsequently, the abnormal condition detection unit 102 analyzes the inspection target image, and inspects whether dust is adhered to the reading face of the image reading device 101 (step S502). When no dust is adhered to the reading face of the image reading device 101 (NO in step S502), and the process ends. On the other hand, when dust is adhered to the reading face of the image reading device 101 (YES in step S502), and the process moves to the distance calculation process (step S503).

Specifically, the distance calculation unit 103 analyzes the inspection target image, calculates the distance from the reference point of the image reading device 101 to the dust adhesion point (step S503), and sends the calculation result to the display control unit 104. Then, the display control unit 104 displays the calculation result that is the distance from the reference point to the dust adhesion point and the inspection target image on the panel display 117a, and outputs a notification to the user (step S504).

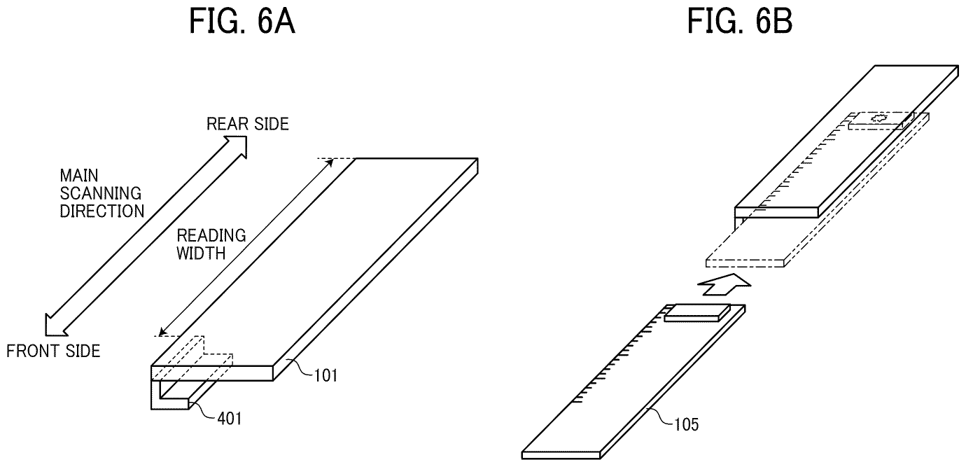

A description is given below of an example of the image reading device with a guide in the detection system 100 according to the present embodiment with reference to FIGS. 6A and 6B.

FIGS. 6A and 6B are diagrams illustrating an example of the image reading device with a guide in the detection system according to the first embodiment of the present disclosure.

As illustrated in FIG. 6A, a guide 401 is an L-shaped guide attached to the front side end of the image reading device 101. The guide 401 can provide a gap in the vertical direction in accordance with the thickness of the cleaning member 105. By contacting the cleaning member 105 to the guide 401 (FIG. 6B), the cleaning member 105 can be fixed at a correct angle with respect to the image reading device 101.

### Second Embodiment

The present embodiment is an example of a detection system including having an automatic cleaning unit that automatically cleans the reading face. The following description of the present disclosure, the description of the configuration or components similar to the configuration or components according to the first embodiment of the present disclosure will be omitted.

FIG. 7-1 is a diagram illustrating an example of the functional configuration of the detection system according to a second embodiment of the present disclosure.

FIG. 7-2 is a diagram illustrating an example of an automatic cleaning on the reading face in the detection system according to the second embodiment of the present disclosure.

In the present embodiment, the detection system 100 includes the image reading device 101, the abnormal condition detection unit 102, the distance calculation unit 103, the display control unit 104, and an automatic cleaning unit 701. The automatic cleaning unit 701 is a concave cleaning member that automatically cleans the reading face of the image reading device 101. The automatic cleaning unit 701 has a concave portion where a sponge 702 is disposed to remove dust adhered to the reading face of the image reading device 101. As the automatic cleaning unit 701 moves on any position along a rail mechanism 703 (as an example of a guide), the reading face can be automatically cleaned.

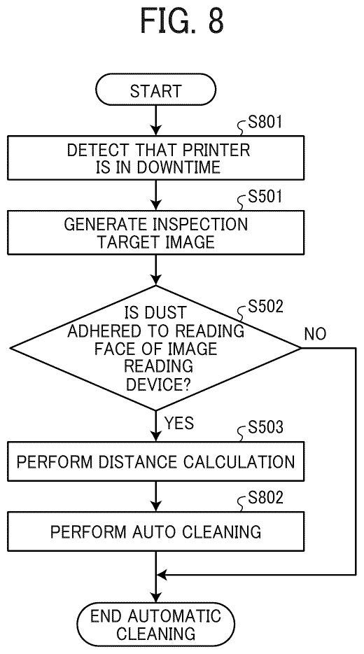

A description is given below of an example of the flow of a cleaning operation on the reading face in the detection system 100 according to the present embodiment with reference to FIG. 8.

FIG. 8 is a flowchart of an example of the cleaning operation on the reading face in the detection system according to the second embodiment of the present disclosure.

Firstly, when it is detected that the printer 10 is in the downtime (step S801), the image reading device 101 generates an inspection target image without feeding a sheet (step S501), and sends the inspection target image to the abnormal condition detection unit 102, the distance calculation unit 103, and the display control unit 104.

Subsequently, the abnormal condition detection unit 102 analyzes the inspection target image, and inspects whether dust is adhered to the reading face of the image reading device 101 (step S502). When no dust is adhered to the reading face of the image reading device 101 (NO in step S502), and the process ends. On the other hand, when dust is adhered to the reading face of the image reading device 101 (YES in S502), and the process moves to the distance calculation process (step S503).

Specifically, the distance calculation unit 103 analyzes the inspection target image, calculates the distance from the reference point of the image reading device 101 to the dust adhesion point (step S503), and sends the calculation result to the automatic cleaning unit 701. The automatic cleaning unit 701 performs automatic cleaning on the reading face of the image reading device 101, in other words, automatically cleans the reading face of the image reading device 101, based on the distance from the reference point to the dust adhesion point (step S802). Specifically, the automatic cleaning unit 701 moves along the rail mechanism 703 based on the distance from the reference point to the dust adhesion point to perform automatic cleaning on the reading face of the image reading device 101. In the present embodiment, by taking the period of time after a printing on a given number of sheets is completed as a downtime, the automatic cleaning unit 701 may perform the automatic cleaning on the reading face of the image reading device 101.

As described above, since the detection system 100 according to the first and second embodiments includes the cleaning member 105 used when cleaning the reading face provided with the scale to measure the position from the reference point to the cleaning target portion, the cleaning member 105 can be placed at the target position by simply looking a scale of the cleaning member 105 without looking into the image reading device 101 from below and easily perform a cleaning.

Although, in the above embodiments, the description is provided is of a case in which the image forming apparatus according to the embodiments is a multifunction peripheral having at least two of the copier function, the printer function, the scanner function, and the facsimile function, this is merely one example. In another example, aspects of this disclosure are applicable to any image forming apparatus such as a copier, a printer, a scanner, or a facsimile machine.

A description is given below of some aspects according to the present disclosure.

### Aspect 1

In Aspect 1, a detection system includes an image reader, an abnormal condition detection unit, a distance calculation unit, a display unit, and a cleaning member. The has a reading face. The abnormal condition detection unit detects that a foreign matter is adhered to the reading face of the image reader. The distance calculation unit calculate a distance between a foreign matter adhesion point where the foreign matter detected is adhered to the reading face of the image reader and a reference point on the reading face of the image reader, in a first direction of the reading face of the image reader. The display unit displays the distance calculated by the distance calculation unit. The cleaning member is movable in the first direction and removes the foreign matter adhered to the reading face of the image reader. The cleaning member is provided along the first direction and has a scale corresponding to the distance displayed on the display unit.

### Aspect 2

In Aspect 2, in the detection system according to Aspect 1, the distance calculation unit calculates the distance from the reference point to the foreign matter adhesion point using an inspection target image generated by performing reading without feeding a sheet by the image reader. The display unit displays the inspection target image and the distance calculated by the distance calculation unit.

### Aspect 3

In Aspect 3, in the detection system according to Aspect 1 or 2, the image reader includes a guide to fix the cleaning member parallel to the reading face of the image reader.

### Aspect 4

In Aspect 4, in the detection system according to Aspect 3, the display unit displays play displays a step of cleaning by the cleaning member by contacting the cleaning member to the guide.

### Aspect 5

In Aspect 5, the detection system according to any one of Aspects 1 to 4 further includes an automatic cleaner to automatically clean the reading face of the image reader based on a calculation result of the distance calculated by the distance calculation unit.

### Aspect 6

In Aspect 6, in the detection system according to Aspect 5, the automatic cleaner performs the automatic cleaning on the reading face of the image reader when it is detected that the operation has transitioned to a downtime.

### Aspect 7

In Aspect 7, a detection method executed in a detection system including detecting a foreign matter adhered to a reading face of an image reader, calculating a distance between a foreign matter adhesion point where the foreign matter detected is adhered to the reading face and a reference point on the reading face of the image reader, in a direction of the reading face, displaying the distance calculated, and removing the foreign matter adhered to the reading face of the image reader by a cleaner movable in the direction of the reading face. The cleaner has a scale formed in the direction of the reading face and corresponding to the distance displayed on the display.

### Aspect 8

In Aspect 8, an image forming apparatus includes a detection system according to any one of Aspects 1 to 6.

### Aspect 9

In Aspect 9, a detection system includes an image reader, circuitry, a display, and a cleaner. The image reader has a reading face to read, in a scanning direction, an image on a sheet fed on the reading face. The circuitry is to detect a foreign matter adhered to the reading face, and calculate a distance, in the scanning direction, between an adhesion point where the foreign matter is adhered to the reading face and a reference point on the reading face. The display displays the distance calculated. The cleaner has a scale in the scanning direction. The scale corresponds to the distance displayed on the display, and is movable in the scanning direction to remove the foreign matter adhered to the reading face.

### Aspect 10

In Aspect 10, in the detection system according to Aspect 9, the image reader reads the image on the reading face without feeding the sheet to the reading face. The circuitry is further to generate a target image based on the image read by the image reader, and calculate the distance based on the target image. The display displays the target image and the distance calculated.

### Aspect 11

In Aspect 11, in the detection system according to Aspect 9 or 10, the image reader further includes a guide to guide the cleaner parallel to the reading face in the scanning direction.

### Aspect 12

In Aspect 12, in the detection system according to Aspect 11, the display displays a step of inserting the cleaner through the guide, and clean the reading face at the adhesion point by the cleaner.

### Aspect 13

In Aspect 13, in the detection system according to any one of Aspects 9 to 12, the circuitry is further to drive and move the cleaner to the adhesion point in the scanning direction to remove the foreign matter adhered to the reading face.

### Aspect 14

In Aspect 14, in the detection system according to Aspect 13, the circuitry is further to drive and move the cleaner top clean the reading face in response to a transition to a downtime of the detection system.

### Aspect 15

In Aspect 15, an image forming apparatus includes a detection system according to any one of Aspects 9 to 14.

### Aspect 16

In Aspect 16, a detection method executed in a detection system including detecting a foreign matter adhered to a reading face of an image reader, calculating a distance, in a scanning direction, between an adhesion point where the foreign matter is adhered to the reading face and a reference point on the reading face of the image reader, displaying the distance calculated, and removing the foreign matter adhered to the reading face of the image reader by a cleaner having a scale in the scanning direction, the scale corresponding to the distance displayed on the display.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A detection system comprising:
an image reader having a reading face to read, in a scanning direction, an image on a sheet fed on the reading face;
circuitry configured to:
detect a foreign matter adhered to the reading face; and
calculate a distance, in the scanning direction, between:
an adhesion point where the foreign matter is adhered to the reading face; and
a reference point on the reading face;
a display to display the distance calculated; and
a cleaner:
having a scale in the scanning direction, the scale corresponding to the distance displayed on the display; and
movable in the scanning direction to remove the foreign matter adhered to the reading face.

2. The detection system according to claim 1,
wherein the image reader reads the image on the reading face without feeding the sheet to the reading face,
the circuitry is further configured to:
generate a target image based on the image read by the image reader; and
calculate the distance based on the target image, and
the display displays:
the target image; and
the distance calculated.

3. The detection system according to claim 1,
wherein the image reader further includes a guide to guide the cleaner parallel to the reading face in the scanning direction.

4. The detection system according to claim 3,
wherein the display displays a step of:
inserting the cleaner through the guide; and
clean the reading face at the adhesion point by the cleaner.

5. The detection system according to claim 1,
wherein the circuitry is further configured to drive and move the cleaner to the adhesion point in the scanning direction to remove the foreign matter adhered to the reading face.

6. The detection system according to claim 5,
wherein the circuitry is further configured to drive and move the cleaner top clean the reading face in response to a transition to a downtime of the detection system.

7. An image forming apparatus comprising the detection system according to claim 1.

8. A detection method executed in a detection system, the detection method comprising:
detecting a foreign matter adhered to a reading face of an image reader;
calculating a distance, in a scanning direction, between:
an adhesion point where the foreign matter is adhered to the reading face; and
a reference point on the reading face of the image reader;
displaying the distance calculated; and
removing the foreign matter adhered to the reading face of the image reader by a cleaner having a scale in the scanning direction, the scale corresponding to the distance displayed on the display.
